(19) United States
(12) Patent Application Publication
(10) Pub. No.: US 2018/0099726 A1
(43) Pub. Date: Apr. 12, 2018

(54) EXPANDABLE FLOORING SYSTEM FOR A PONTOON BOAT

(71) Applicants: William Stacey BROADWAY, Monroe, NC (US); Patrick W. DUNCAN, Marshville, NC (US); Jamie Lynn RUSHING, Marshville, NC (US); Edward Anthony WASILEWSKI, Monroe, NC (US); Barry RUSHING, Marshville, NC (US)

(72) Inventors: William Stacey BROADWAY, Monroe, NC (US); Patrick W. DUNCAN, Marshville, NC (US); Jamie Lynn RUSHING, Marshville, NC (US); Edward Anthony WASILEWSKI, Monroe, NC (US); Barry RUSHING, Marshville, NC (US)

(21) Appl. No.: 15/729,592

(22) Filed: Oct. 10, 2017

Related U.S. Application Data
(60) Provisional application No. 62/406,057, filed on Oct. 10, 2016.

(51) Int. Cl. B63B 7/04; B63B 35/34; B63B 3/48; B60P 3/34

(52) U.S. Cl. CPC B63B 7/04; B63B 35/34; B63B 2007/003; B60P 3/34; B63B 3/48

(57) ABSTRACT

An expandable flooring system for a pontoon boat includes a center floor and at least one outer floor. The outer floor is configured to hinge upwards about an edge of the center floor. At least one outrigger is extendable from a corresponding slide track under the center floor. The outrigger is configured to slide under the center floor when the outer floor is hinged upward, and slide out from the center floor for supporting the outer floor when it is hinged down and next to the center floor. A railing system surrounds the periphery of the flooring system and is secured together for providing rigidity to the flooring system.

### CROSS-REFERENCE TO RELATED APPLICATIONS

This application claims benefit of priority application, U.S. Provisional Ser. No. 62/406,057 filed on Oct. 10, 2016 entitled “Extended Use Pontoon Device”, which is incorporated herein by reference in its entirety.

### FIELD OF THE DISCLOSURE

The present disclosure relates to boats, campers, RVs, and the like. More specifically, the instant disclosure relates to an expandable flooring system for a pontoon boat, camper, RV, or other like devices.

### BACKGROUND

A pontoon is a flotation device with buoyancy sufficient to float itself as well as a heavy load. A pontoon boat is a flattish boat that relies on pontoons to float. Pontoons may be used on boats, rafts, barges, docks, airboats, hovercrafts, floatplanes or seaplanes. Pontoons may support a platform, creating a raft. A raft supporting a house-like structure is a houseboat. A fixed platform can be used as a dock. Pontoons may be simply constructed from sealed cylinders such as pipes or barrels, or fabricated as boxes from metal or concrete. These pontoons, or tubes for short, contain a lot of reserve buoyancy and allow designers to create massive deck plans fitted with all sorts of accommodations, such as expansive lounge areas, stand-up bars, and sun pads. Pontoon boat drafts may be as shallow as eight inches, which reduces risk of running aground and underwater damage. Pontoon boats for pleasure boating and fishing can be low cost for their capacity, and cheaper to insure than other boats, even when equipped with substantial engines. Pontoon boats are used as small vehicle ferries to cross rivers and lakes in many parts of the world. Pontoon ferries may be motorized, or powered by another boat, or pulled by cables.

The present disclosure may relate to a system for boat expansion, like expansion of a pontoon boat, or like devices, including campers, RVS, etc. A pontoon boat, also referred to as a party boat, is ideal for large gatherings and parties on the water. As such, there is clearly a desire to provide larger space or flooring on such pontoon or party boats. However, pontoon boats are designed to be towed behind a vehicle for transportation. As such, the width of the pontoon boat is limited by highway regulations to be able to be towed and transported on roads without a permit. As such, boats such as pontoon boats may have an average width between 6 and 10 feet. As such, there is clearly a need or desire to provide a pontoon boat that is expandable beyond the average width of pontoon boats to provide a larger floor space or area on the boat.

Expandable boats, or expandable pontoon boat designs, in particular, are known to have been attempted in the past. However, all of these known designs for expandable pontoon boats have failed to address four major concerns, such as: 1) maximizing the deck space of the boat once expanded, while still having a package that can be transported on a typical highway; 2) allowing for maximum cargo carrying capability; 3) ensuring a rigid structure once expanded; and 4) ability to maintain a center console platform rather than a side console to maximize deck usage once expanded.

U.S. Pat. Nos. 8,820,255, 9,045,195 and 9,580,149 show a known expandable and contracting pontoon boat that is manufactured by Island Boats of Vero Beach, Fla. This expandable and contractible pontoon boat can be expanded only a little over 2 linear feet. This greatly limits the potential deck space that could be utilized with a different method of expansion. This limitation may be because of the way the floor slides under itself for retraction.

U.S. Pat. No. 6,003,458 discloses another design for an expandable pontoon boat. The deck in this design can expand no more than two times its original size due to the expansion method of the pontoons. This method can also potentially allow the boat to flex more than desired.

U.S. Pat. No. 9,156,526 discloses an expandable pontoon system. The design of this system is also limited to a maximum of two times the original platform growth due to the method in which the outer decks slide over the center deck. This design is also affixed solely around a three-pontoon system, which can potentially limit the cargo carrying capability.

U.S. Pat. No. 6,874,440 discloses an expandable multi-hull boat. The design of this boat is limited as to how wide it can expand and contract due to the method of having the expansion rails slide completely inside of each other. This limits how close the outer pontoons can be collapsed for transportation and also limits offering additional pontoons under the boat for additional load carrying capability.

The majority of these known designs are attempting to take an existing pontoon boat (existing referring to current width and length) and make it collapsible to a size that can be more easily transported on the highway or stored. On the other hand, the instant disclosure may be the opposite, as it may start with the maximum width of boat that can safely be towed behind a vehicle and allows that boat to expand to a larger usable deck space.

The instant disclosure of an expandable flooring system for a pontoon boat may be designed to solve at least some aspects of the problems disclosed above.

### SUMMARY

Briefly described, in a possibly preferred embodiment, the present disclosure overcomes the above-mentioned disadvantages and meets the recognized need for such an apparatus or method by providing an expandable flooring system for a pontoon boat. The expandable flooring system for a pontoon boat may generally include a center floor and at least one outer floor. The outer floor is configured to hinge upwards about an edge of the center floor. At least one outrigger is extendable from a corresponding slide track under the center floor. The outrigger is configured to slide under the center floor when the outer floor is hinged upward, and slide out from the center floor for supporting the outer floor when it is hinged down and next to the center floor. A foldable railing system surrounds the periphery of the flooring system and is secured together for providing rigidity to the flooring system.

In one aspect, the expandable flooring system may include the features of the outer floor or floors hinging or folding on top of the center floor. As such, the expandable flooring system may include the center floor, and at least one outer floor configured to hinge or fold upwards about an edge of the center floor. Wherein, the expandable flooring system is configured to expand by said at least one outer floor hinging downwards flat beside said center floor and configured to retract by the at least one outer floor hinging upwards and on top of the center floor.

One feature of this folding or hinging aspect of the expandable flooring system may be that each of the at least one outer floors may include an inner section hingidly attached to an outer section. Whereby, when the outer floor hinges upwards for retracting of the expandable flooring system, the outer floor hinges together the inner section and the outer section for conserving space on the center floor. In select embodiments, the inner section hinges on top of the center floor, and the outer section hinges on top of the inner section.

Another feature of this folding or hinging aspect of the expandable flooring system may be that the outer section may have railings hingidly fixed to an outer edge. Whereby, when the outer floor hinges upwards for retracting of the expandable flooring system, the outer floor may hinge together the inner section and the outer section for conserving space on the center floor, wherein the inner section hinges on top of the center floor, the outer section hinges on top of the inner section, and the railings hinge on top of the outer floor.

In select embodiments, the expandable flooring system may include the center floor, a first outer floor configured to hinge upwards about a first edge of the center floor, and a second outer floor configured to hinge upwards about a second edge of the center floor. In this embodiment, the expandable flooring system may be configured to expand by the first outer floor and the second outer floor hinging downwards flat beside the center floor. A first outer pontoon may support the first outer floor and a second outer pontoon may support the second outer floor. As such, the expandable flooring system may be configured to retract by the first outer floor and the second outer floor hinging upwards and on top of the center floor. In select embodiments, the first and the second outer floors including an inner section hingidly attached to an outer section, whereby, when the first and second outer floors hinge upwards for retracting of the expandable flooring system, the outer floors hinge together the inner section and the outer section for conserving space on the center floor. Wherein, the inner sections hinge on top of the center floor, and the outer sections hinge on top of the inner sections. In select embodiments, each of the first and second outer sections may have railings hingidly fixed to an outer edge. Whereby, when the first and second outer floors hinge upwards for retracting of the expandable flooring system, the first and second outer floors may hinge together the inner section and the outer section for conserving space on the center floor. Wherein, the inner sections hinge on top of the center floor, the outer sections hinge on top of their respective inner section, and the railings hinge on top of their respective outer floor.

In another aspect, the expandable flooring system may include the feature of the slide track system for supporting the outer floor when expanded. As such, the expandable flooring system may include the center floor, at least one outer floor, and a slide track system. The slide track system may be configured to support the at least one outer floor when it is expanded out beside the center floor and to slide under the center floor when the at least one outer floor is retracted. The slide track system may generally include at least one outrigger that is extendable from a corresponding slide track under the center floor. As such, the outrigger may be configured to slide inside the slide track under the center floor when the outer floor is retracted. In addition, the outrigger may be configured to slide out from the slide track and from under the center floor for supporting the outer floor when it is expanded out beside the center floor.

One feature of the slide track system for the expandable flooring system may be that each of the at least one outriggers may have its own corresponding slide track under the center floor. As a result, each of the corresponding slide tracks may extend under the center floor for a width of the center floor. Whereby the outrigger may be extendable from the slide track an extension width which is approximately the width of the center floor.

Another feature of the slide track system for the expandable flooring system may be that each of the at least one outriggers may be cantilevered with its corresponding slide track for supporting the outrigger when it is slid out from the center floor for supporting the outer floor when it is expanded out beside the center floor. In select embodiments, each of the at least one outriggers may have a rectangular cross-section or a circular cross-section, and its corresponding slide track may have a rectangular channel or a circular channel (i.e. tubular channel) configured to allow the rectangular or circular outrigger to slide therein while providing cantilever forces.

In select embodiments of the slide track system for the expandable flooring system, the system may include at least two (2) pontoons. These two (2) pontoons may include at least one outer pontoon connected to the at least one outrigger.

In select embodiments of the slide track system for the expandable flooring system, the system may include the center floor, a first outer floor connected to a first edge of the center floor, and a second outer floor connected to a second edge of the center floor. In this embodiment, the slide track system may be configured to support the first outer floor and the second outer floor when they are expanded out beside the center floor and to slide under the center floor when the first outer floor and the second outer floor are retracted. The slide track system of this embodiment may include at least one first outrigger and at least one second outrigger. The at least one first outrigger may be extendable from a corresponding first slide track under the center floor. The first outrigger may be configured to slide in the first slide track under the center floor when the first outer floor is retracted, and slide out from the first slide track and from the center floor for supporting the first outer floor when it is expanded out beside the center floor. The at least one second outrigger may be extendable from a corresponding second slide track under the center floor. The second outrigger may be configured to slide in the second slide track under the center floor when the second outer floor is retracted, and slide out from the second slide track and from the center floor for supporting the second outer floor when it is expanded out beside the center floor.

In select embodiments, the slide track system may include five first outriggers and five corresponding first slide tracks, and five second outriggers and five corresponding second slide tracks.

In other select embodiments, the slide track system may include three first outriggers and three corresponding first slide tracks, and three second outriggers and three corresponding second slide tracks.

In select embodiments, the slide track system may include four pontoons. A first inner pontoon may be slidable under the center floor. A second inner pontoon may be slidable under the center floor. A first outer pontoon may be connected to each of the at least one first outriggers. A second outer pontoon may be connected to each of the at least one second outriggers. Whereby, when the expandable flooring system is in the expanded form, the first outer pontoon supports the first outer floor, the second outer pontoon supports the second outer floor, and the first and second inner pontoons slide to the edges of the center floor for stabilizing the center floor. And when the expandable flooring system is in the retracted form, the first outer pontoon, the second outer pontoon, the first inner pontoon and the second inner pontoon slide beneath the center floor.

One feature of the slide track system for the expandable flooring system may be that the inner pontoons may be connected to their corresponding slide tracks via slide collars. The slide collars may be configured to slide along the slide tracks.

Another feature of the slide track system for the expandable flooring system may be that the outer pontoons may be connected to their corresponding outriggers via cantilever collars. The cantilever collars may be configured to provide cantilever forces to support the outer floors.

In another aspect, the expandable flooring system may include the feature of the foldable railing system that links together when expanded for reinforcing the expandable flooring system. As such, the expandable flooring system may include the center floor, at least one outer floor configured to expand beside the center floor, and a railing system around a periphery of the expandable flooring system when in expanded form. The railing system may be configured to link together railing sections of the center floor with railing sections of the at least one outer floor for reinforcing the expandable flooring system. The railing system may be configured to fold down when the expandable flooring system is retracted.

In select embodiments of the expandable flooring system with the railing system, the center floor may include two ends. Each of the two ends of the center floor may include a center end railing secured thereon. The at least one outer floor may include two ends and a side opposite of the center floor, each of the two ends including an outer end railing hingidly secured thereon, and the side opposite of the center floor including a side railing hingidly secured thereon. Whereby, when the outer floor is expanded beside the center floor, each of the outer end railings may be configured to flip up and secure to the corresponding center end railing. The side railing may be configured to flip up and secured at its ends to the outer end railings.

In select embodiments of the expandable flooring system with the railing system, when the at least one outer floor includes an inner section hingidly connected to an outer section, the inner section may include two ends and the outer section may include two ends, where each of the two ends of the inner section and the outer section may include an outer end railing section hingidly secured thereon. Whereby, when the outer end railings of the inner section and the outer section are flipped up, the outer end railings of the inner section and the outer section may be secured end to end.

In select embodiments of the expandable flooring system with the railing system, the outer end railings may overlap the center end railings.

In select embodiments of the expandable flooring system with the railing system, the expandable flooring system may include the center floor, a first outer floor configured to expand beside the center floor on one side, and a second outer floor configured to expand beside the center floor on another side. The first outer floor may include two ends and a side opposite of the center floor, each of the two ends may include an outer end railing hingidly secured thereon, and the side opposite of the center floor may include a side railing thereon. The second outer floor may include two ends and a side opposite of the center floor, each of the two ends may include an outer end railing hingidly secured thereon, and the side opposite of the center floor may include a side railing thereon. Whereby, when the first and the second outer floors are expanded beside the center floor, each of the outer end railings may be configured to flip up and secure to the corresponding center end railing, and the side railings may be configured to flip up and secured at its ends to the outer end railings.

The foregoing illustrative summary, as well as other exemplary objectives and/or advantages of the disclosure, and the manner in which the same are accomplished, may become more apparent to one skilled in the art from the prior Summary, and the following Brief Description of the Drawings, Detailed Description, and Claims when read in light of the accompanying Detailed Drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 schematically depicts a perspective top view of select embodiments of the expandable flooring system for a pontoon boat according to the instant disclosure, in a partially folded form;

FIG. 2 schematically depicts a perspective top view of select embodiments of the expandable flooring system for a pontoon boat of FIG. 1 in an extended form;

FIG. 3 schematically depicts an end view of select embodiments of the expandable flooring system for a pontoon boat of FIG. 1, in a partially folded form;

FIG. 4 schematically depicts an end view of select embodiments of the expandable flooring system for a pontoon boat of FIG. 2 in an extended form;

FIG. 5 schematically depicts a perspective top view of select embodiments of the expandable flooring system for a pontoon boat of FIG. 2 in an extended form zoomed in on the railings overlapping and locking in place for rigidity;

FIG. 6 schematically depicts select embodiments of the slide track system for the pontoons of the expandable flooring system for a pontoon boat according to the instant disclosure;

FIG. 7 schematically depicts select embodiments of the slide track system for one side of the pontoons of the expandable flooring system for a pontoon boat shown in FIG. 6;

FIG. 8 schematically depicts a side view of select embodiments of the expandable flooring system for a pontoon boat according to the instant disclosure showing the end view of the slide track system;

FIG. 9 shows a perspective top view of select embodiments of the slide track system for the expandable flooring system according to the instant disclosure; and

FIG. 10 shows a perspective top view of the first outer pontoon with its circular cross-section outriggers connected by cantilever collars removed from the slide track system of FIG. 9 according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

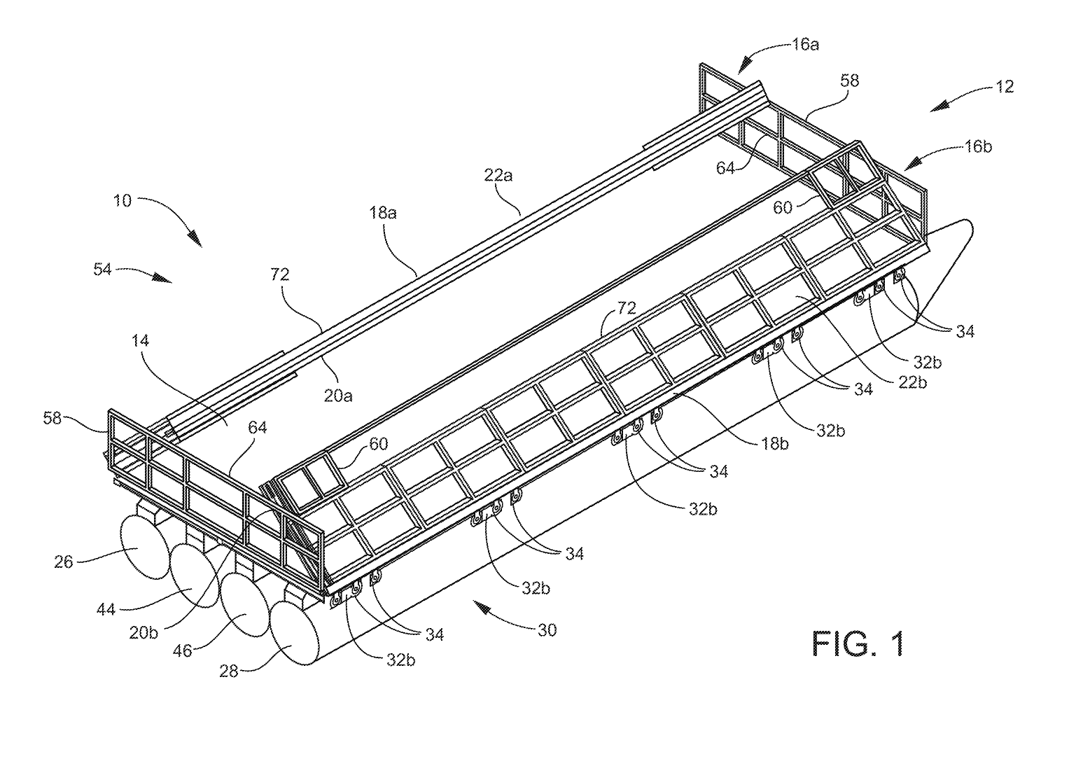

Referring now to FIGS. 1-10, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

The present disclosure overcomes the above-mentioned disadvantages and meets the recognized need for such an apparatus or method by providing of expandable flooring system 10 for pontoon boat 12. Although expandable flooring system 10 may be described and shown for use on pontoon boat 12, the disclosure is not so limited, and expandable flooring system 10 may be used on any device or vehicle needing or desiring expandable flooring system 10, including, but not limited to, boats, campers, RVs, the like, etc. The present disclosure overcomes the above-mentioned disadvantages and meets the recognized need for such an apparatus or method by providing expandable flooring system 10 for pontoon boat 12. Expandable flooring system 10 for pontoon boat 12 may generally include center floor 14 and at least one outer floor 16. The outer floor 16 may be configured to hinge upwards about edge 18 of center floor 14. At least one outrigger 32 may be extendable from a corresponding slide track 34 under center floor 14. Each outrigger 32 may be configured to slide under center floor 14 when outer floor 16 is hinged upward in a retracted form, and slide out from center floor 14 for supporting outer floor 16 when it is hinged down and next to center floor 14, in the extended form. Foldable railing system 54 may surround the periphery 56 of the flooring system 10 and may be secured together for providing rigidity to the flooring system 10.

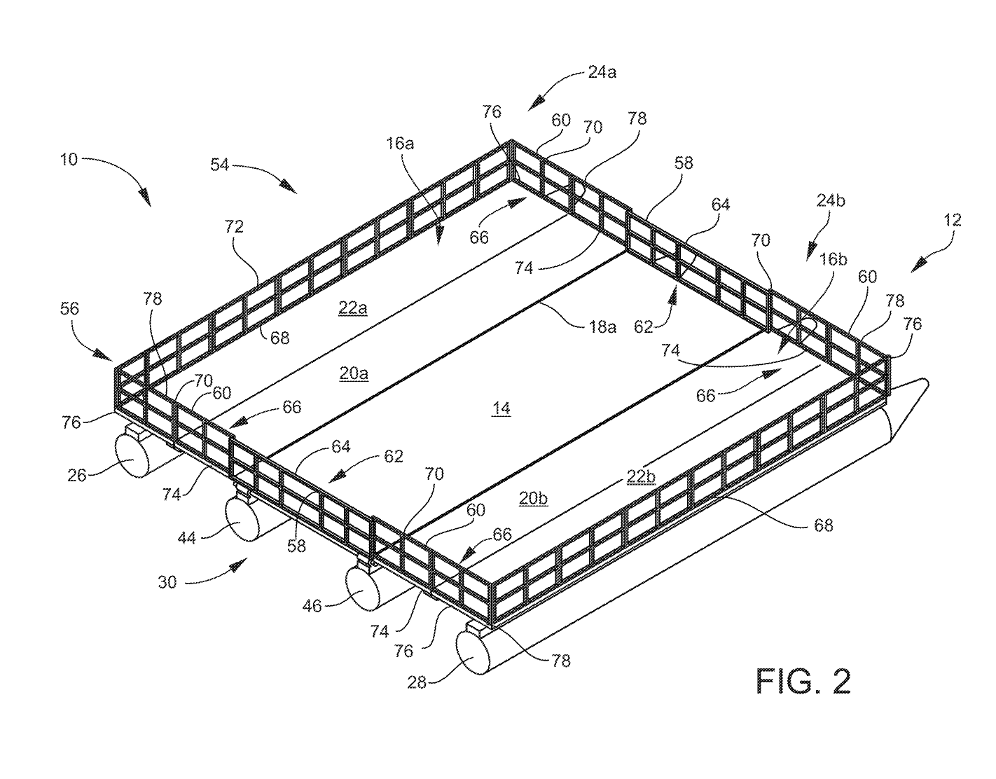

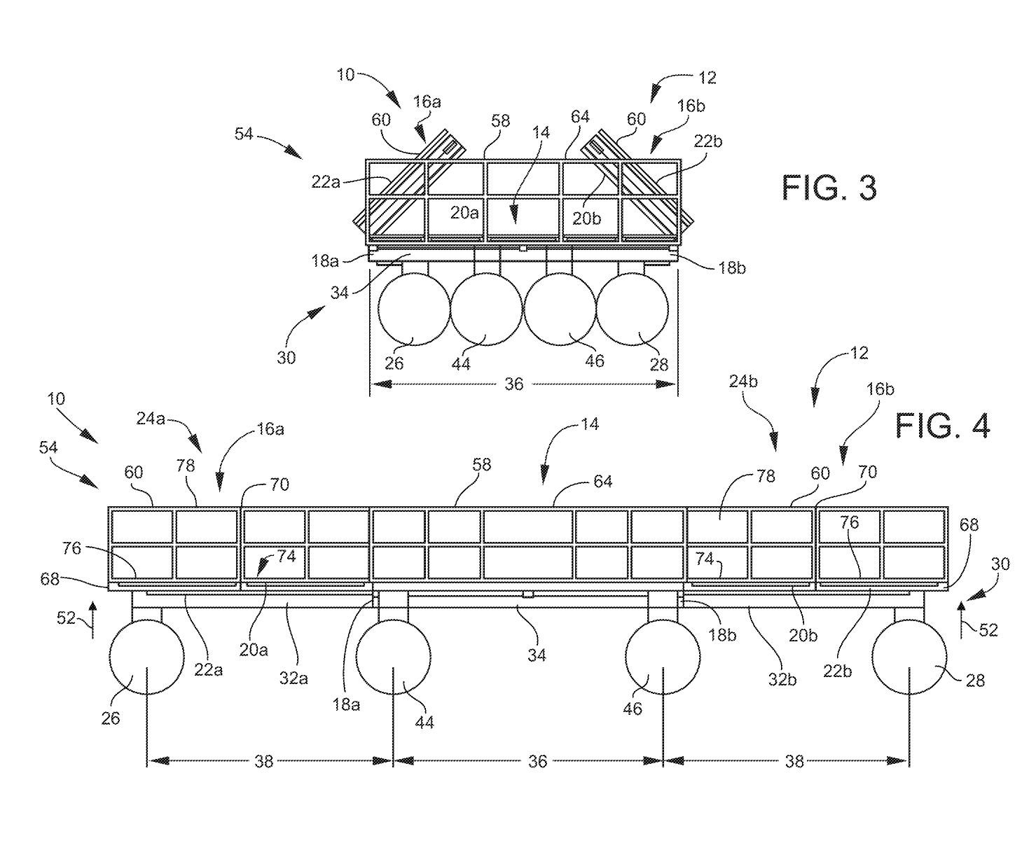

Referring now specifically to FIGS. 1-4, in one aspect, expandable flooring system 10 may include the features of the outer floor 16 or outer floors 16 hinging or folding on top of center floor 14. As such, the expandable flooring system 10 may include the center floor 14, and at least one outer floor 16 configured to hinge or fold upwards about an edge 18 of center floor 14. Wherein, expandable flooring system 10 may be configured to expand by said at least one outer floor 16 hinging downwards flat beside center floor 14, in a parallel or flat orientation for the expanded form (see FIGS. 1 and 3 in a partially expanded form), and configured to retract by the at least one outer floor 16 hinging upwards and on top of center floor 14 for the retracted form (see FIGS. 2 and 4).

One feature of this folding or hinging aspect of the expandable flooring system 10 may be that each of the at least one outer floors 16 may include inner section 20 hingidly attached to outer section 22. This may provide a bi-folding aspect or feature to each outer floor 16. Whereby, when outer floor 16 hinges upwards for retracting of the expandable flooring system 10, the outer floor 16 may hinge or fold together inner section 20 and outer section 22 for conserving space on center floor 161n select embodiments, the inner section 20 may hinge on top of center floor 14, and outer section 22 may hinge on top of inner section 20. See FIGS. 1 and 3 for a schematic representation of the outer section 22 folded on top of the inner section 20, and the outer floor 15 partially folded down on top of center floor 14. This bi-folding aspect of outer floors 16 may allow outer floor 16 to take up half of the space on center floor 14. However, the disclosure is not so limited, and any number of additional folds may be included or various size folds may be included.

Another feature of this folding or hinging aspect of expandable flooring system 10 may be that outer section 22 may have railings 24 hingidly fixed to outer edge or side 68. Whereby, when outer floor 16 hinges upwards for retracting of the expandable flooring system 10, the outer floor 16 may hinge together inner section 20 and outer section 22 for conserving space on center floor 14, wherein inner section 20 hinges on top of center floor 14, outer section 22 hinges on top of inner section 20, and railings 24 hinge on top of outer floor 16. See FIGS. 1 and 3 for a schematic representation of railings 24 folded down on the outer section 22, the outer section 22 folded on top of the inner section 20, and the outer floor 16 partially folded down on top of center floor 14.

As shown in FIGS. 1-4, in select embodiments expandable flooring system 10 may include an outer floor 16 on each side of center floor 14. As such, expandable flooring system 10 may include center floor 14, first outer floor 16a configured to hinge upwards about first edge 18a of center floor 14, and second outer floor 16b configured to hinge upwards about second edge 18b of center floor 14. In this embodiment, the expandable flooring system 10 may be configured to expand by first outer floor 16a and second outer floor 16b hinging downwards flat beside center floor 14. First outer pontoon 26 may support first outer floor 16a and second outer pontoon 28 may support second outer floor 16b. As such, expandable flooring system 10 may be configured to retract by first outer floor 16a and second outer floor 16b hinging upwards and on top of center floor 14. In select embodiments, first and the second outer floors 16a and 16b may include inner sections 20a and 20b, respectively, hingidly attached to outer sections 22a and 22b, respectively. Whereby, when first and second outer floors 16a and 16b hinge upwards for retracting of the expandable flooring system 10, outer floors 16a and 16b hinge together inner sections 20a and 20b, and outer sections 22a and 22b, respectively, for conserving space on center floor 14. Wherein, inner sections 20a and 20b hinge on top of center floor 14, and outer sections 22a and 22b hinge on top of their respective inner section 20a and 20b. See FIGS. 1 and 3. In select embodiments, each of the first and second outer sections 22a and 22b may have railings 24a and 24b hingidly fixed to outer edge or side 68. Whereby, when first and second outer floors 16a and 16b hinge upwards for retracting of expandable flooring system 10, first and second outer floors 16a and 16b may hinge together inner sections 20a and 20b and their respective outer section 22a and 22b for conserving space on center floor 14. Wherein, the inner sections 20a and 20b hinge on top of center floor 14, outer sections 22a and 22b, hinge on top of their respective inner section 20a and 20b, and railings 24a and 24b hinge on top of their respective outer floor 16a and 16b.

Referring now to FIGS. 3, 4, and 6-10, in another aspect, the expandable flooring system 10 may include the feature of the slide track system 30. Slide track system 30 may be for supporting outer floor(s) 16 when expanded. As such, expandable flooring system 10 may include center floor 14, at least one outer floor 16, and slide track system 30. The slide track system 30 may be configured to support the at least one outer floor 16 when it is expanded out beside center floor 14 and to slide under center floor 14 when the at least one outer floor 16 is retracted. The slide track system 30 may generally include at least one outrigger 32 that is extendable from a corresponding slide track 34 under center floor 14. As such, outrigger 32 may be configured to slide inside slide track 34 under center floor 14 when the outer floor 16 is retracted. In addition, outrigger 32 may be configured to slide out from the slide track 34 and from under center floor 14 for supporting outer floor(s) 16 when it is expanded out beside center floor 14.

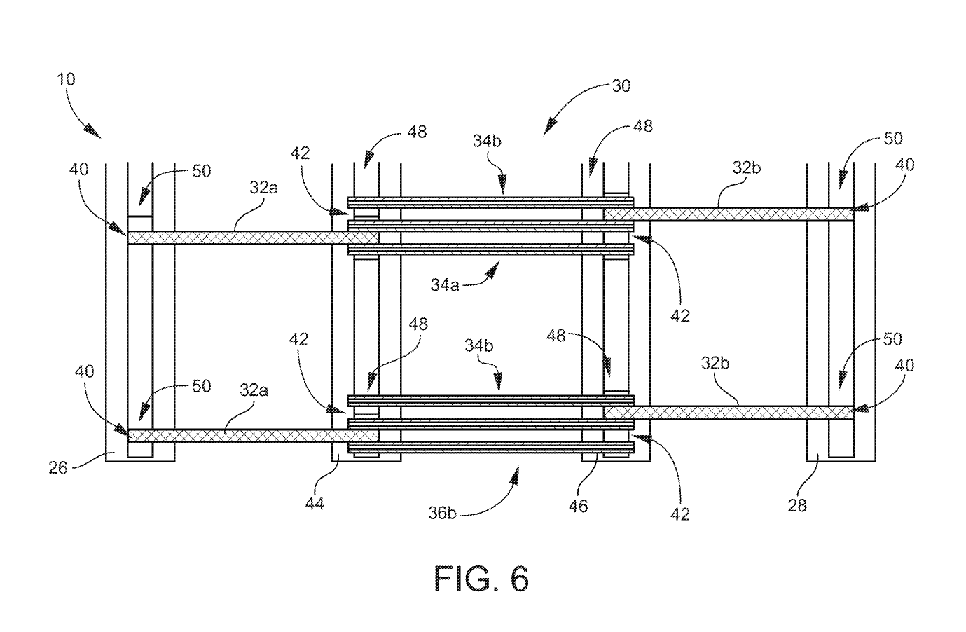

Referring now specifically to FIGS. 6, 7, 9 and 10, one feature of the slide track system 30 for the expandable flooring system 10 may be that each of the at least one outriggers 32 may have its own corresponding slide track 34 under center floor 14. As a result, each of the corresponding slide tracks 34 may extend under center floor 14 for width 36 of center floor 14. Whereby, outrigger 32 may be extendable from slide track 34 extension width 38 which may be up to approximately width 36 of center floor 14. As such, as one example, with one outer floor 16, expandable flooring system 10 may double the flooring space of center floor 14. As another example, as shown in the Figures, with two outer floors 16a and 16b, expandable flooring system 10 may triple the flooring space of center floor 14.

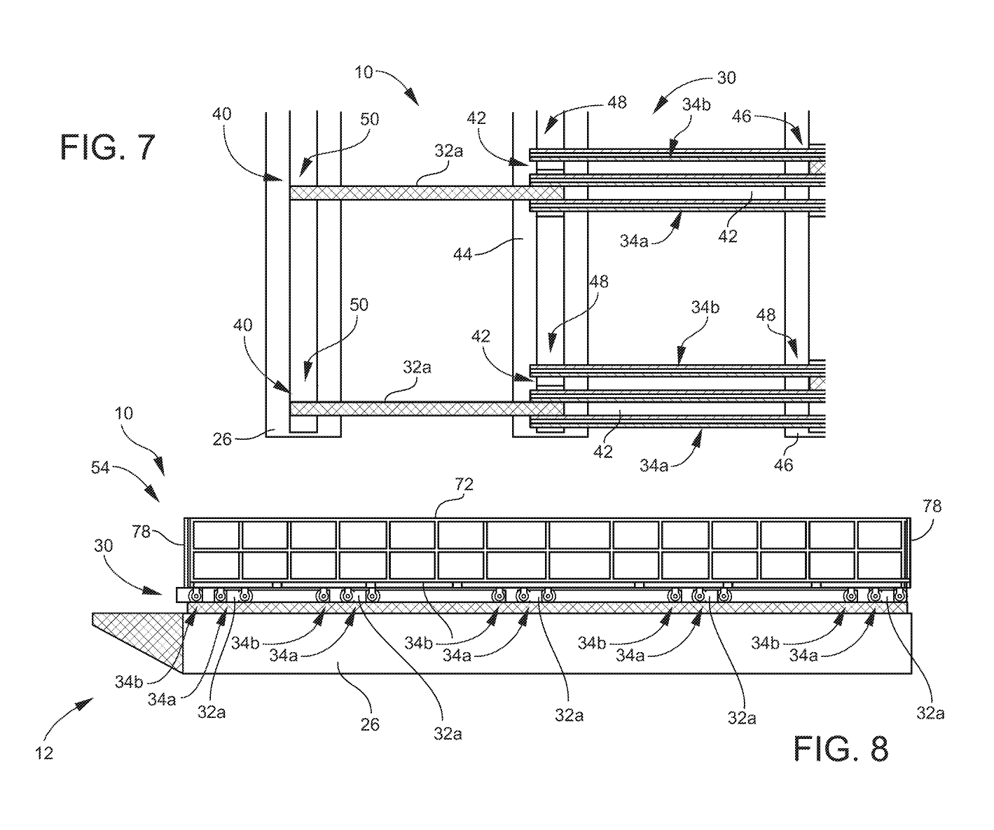

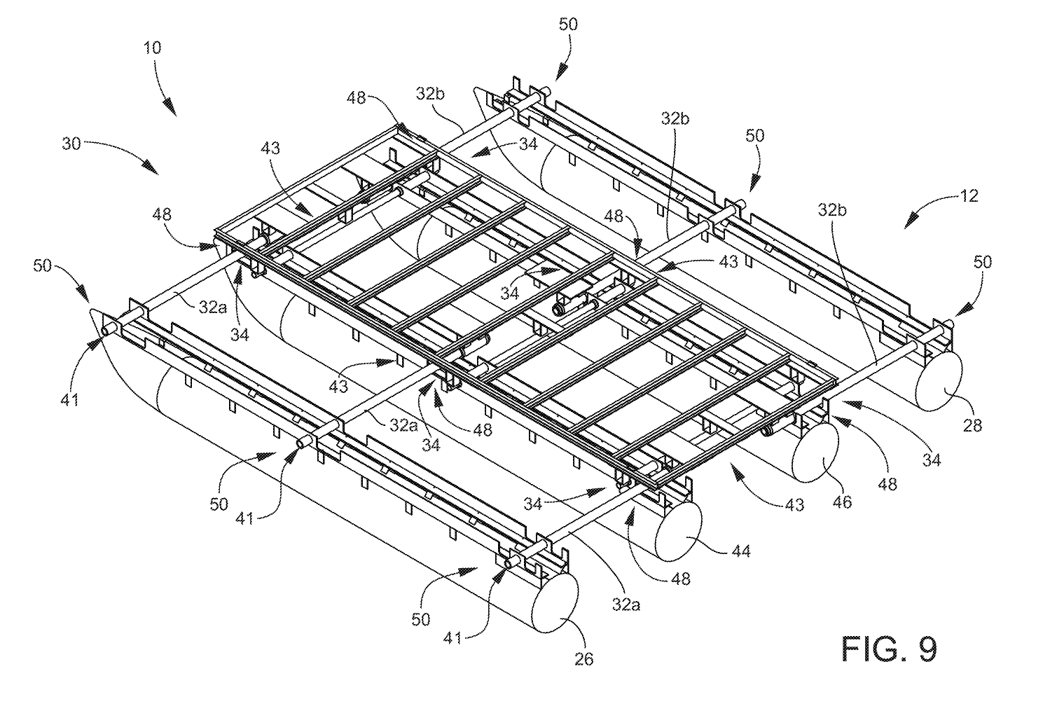

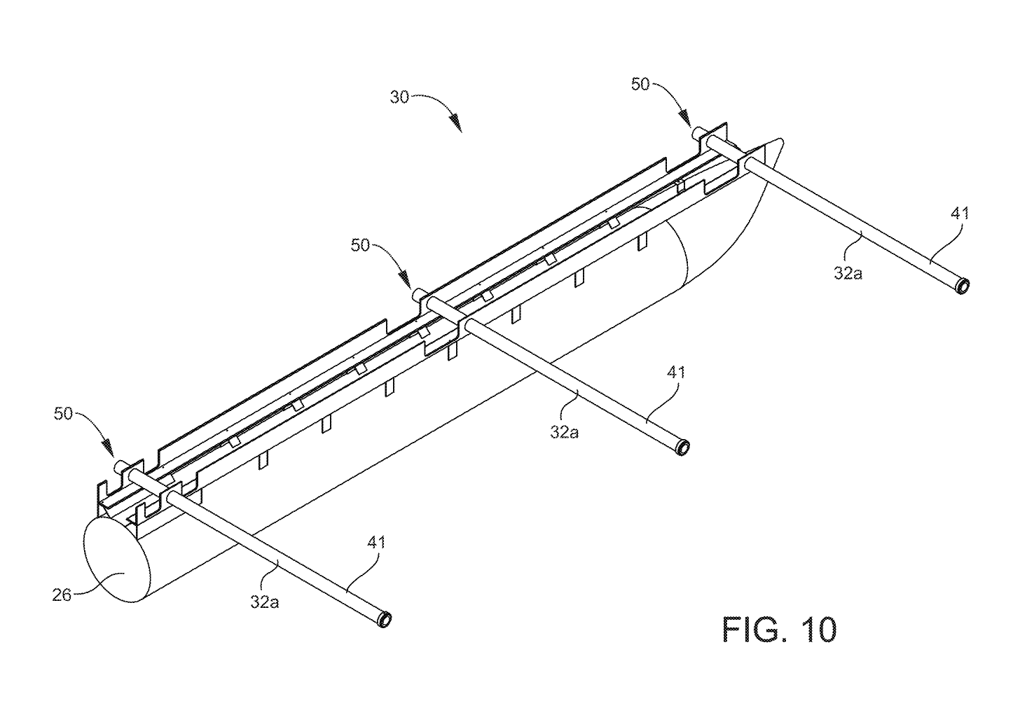

Another feature of slide track system 30 for expandable flooring system 10 may be that each of the at least one outriggers 32 may be cantilevered with its corresponding slide track 34 for supporting outrigger 32 when it is slid out from center floor 14 for supporting the outer floor 16 when it is expanded out beside center floor 14. In select embodiments, each of the at least one outriggers 32 may have rectangular cross-section 40 (see FIGS. 6 and 7) or circular cross-section 41 (see FIGS. 9 and 10), and its corresponding slide track 34 may have rectangular channel 42 or circular channel 43 (i.e. tubular channel) configured to allow rectangular or circular outrigger 32 to slide therein while providing cantilever forces.

In select embodiments of the slide track system 30 for the expandable flooring system 10, the system 10 may include at least two (2) pontoons. These two (2) pontoons may include at least one outer pontoon 26 connected to the at least one outrigger 32.

As shown in the Figures, in select embodiments of the slide track system 30 for the expandable flooring system 10, the system 10 may include center floor 14, first outer floor 16a connected to first edge 18a of center floor 14, and second outer floor 16b connected to second edge 18n of center floor 14. In this embodiment, slide track system 30 may be configured to support first outer floor 16a and second outer floor 16b when they are expanded out beside center floor 14 and to slide under center floor 14 when first outer floor 16a and second outer floor 15b are retracted. The slide track system 30 of this embodiment may include at least one first outrigger 32a and at least one second outrigger 32b. The at least one first outrigger 32a may be extendable from a corresponding first slide track 34a under the center floor 14. The first outrigger(s) 32a may be configured to slide in the first slide track 34a under the center floor 14 when the first outer floor 16a is retracted (see FIGS. 1 and 3), and slide out from the first slide track 34a and from center floor 14 for supporting first outer floor 16a when it is expanded out beside center floor 14 (see FIGS. 2 and 4). The at least one second outrigger 32b may be extendable from a corresponding second slide track 34b under center floor 14. The second outrigger 32a may be configured to slide in second slide track 34b under center floor 14 when the second outer floor 16b is retracted (see FIGS. 1 and 3), and slide out from the second slide track 34b and from center floor 14 for supporting second outer floor 16b when it is expanded out beside center floor 14 (see FIGS. 2 and 4). The slide track system 30 may include any number of desired or needed first outriggers 32a and second outriggers 32b, with the corresponding number of slide tracks 34a and 34b for supporting first outer floor 16a and second outer floor 16b. In select embodiments, the slide track system 30 may include five first outriggers 32a and five corresponding first slide tracks 34a, and five second outriggers 32b and five corresponding second slide tracks 34b. See FIGS. 1 and 8. In other select embodiments, the slide track system 30 may include three first outriggers 32a and three corresponding first slide tracks 34a, and three second outriggers 32b and three corresponding second slide tracks 34b. See FIG. 9.

Referring again to FIGS. 1-5 and 9, in select embodiments, the slide track system 30 may include four pontoons 26, 28, 44 and 46. First inner pontoon 44 may be slidable under center floor 14. Second inner pontoon 46 may also be slidable under center floor 14. First outer pontoon 26 may be connected to each of the at least one first outriggers 32a. Second outer pontoon 28 may be connected to each of the at least one second outriggers 32b. Whereby, when expandable flooring system 10 is in the expanded form (see FIGS. 2 and 4), the first outer pontoon 26 supports the first outer floor 16a, the second outer pontoon 28 supports the second outer floor 16b, and the first and second inner pontoons 44 and 46 slide to the edges of the center floor 14 for stabilizing the center floor 14. And when expandable flooring system 10 is in the retracted form (see FIGS. 1 and 3), the first outer pontoon 26, the second outer pontoon 28, the first inner pontoon 44, and the second inner pontoon 46 may slide beneath the center floor.

One feature of the slide track system 30 for the expandable flooring system 10 may be that the inner pontoons 44 and 46 may be connected to their corresponding slide tracks 34 via slide collars 48. See FIGS. 7-10. The slide collars 48 may be configured to slide along the slide tracks.

Another feature of the slide track system 30 for the expandable flooring system 10 may be that the outer pontoons 26 and 28 may be connected to their corresponding outriggers 32a and 32b via cantilever collars 50. See FIGS. 7-10. The cantilever collars 50 may be configured to provide cantilever forces 52 to support the outer floors 16a and 16b. In select embodiments, as shown in FIGS. 9 and 10, the cantilever collar 50 may include two connection points, one on the inner portion of the top of the pontoon, and one on the outer portion of the top of the pontoon. These two connection points may provide the cantilever forces 52 between outriggers 32 and outer pontoons 26 and 28.

Referring now to FIGS. 1-5 and 8, in another aspect, the expandable flooring system 10 may include the feature of the foldable railing system 54 that links together when expanded for reinforcing the expandable flooring system 10, and folds down when retracted. As such, expandable flooring system 10 may include center floor 14, at least one outer floor 16 configured to expand beside center floor 14, and railing system 54 around periphery 56 of the expandable flooring system 10 when in expanded form (see FIG. 2). The railing system 54 may be configured to link together railing sections 58 of center floor 14 with railing sections 60 of the at least one outer floor 16 for reinforcing the expandable flooring system 10. The railing system 54 may be configured to fold down when the expandable flooring system 10 is retracted.

In select embodiments of the expandable flooring system 10 with the railing system 54, the center floor 14 may include two ends 62. Each of the two ends 62 of the center floor 14 may include center end railings 64 secured thereon. The at least one outer floor 16 may include two ends 66 and side opposite 68 of center floor 14, each of the two ends 66 may include outer end railing 70 hingidly secured thereon, and the side 68 opposite of center floor 14 may include side railing 72 hingidly secured thereon. Whereby, when outer floor 16 is expanded beside center floor 14, each of the outer end railings 70 may be configured to flip up and secure to the corresponding center end railing 64. The side railing 72 may be configured to flip up and secured at its ends to the outer end railings 70.

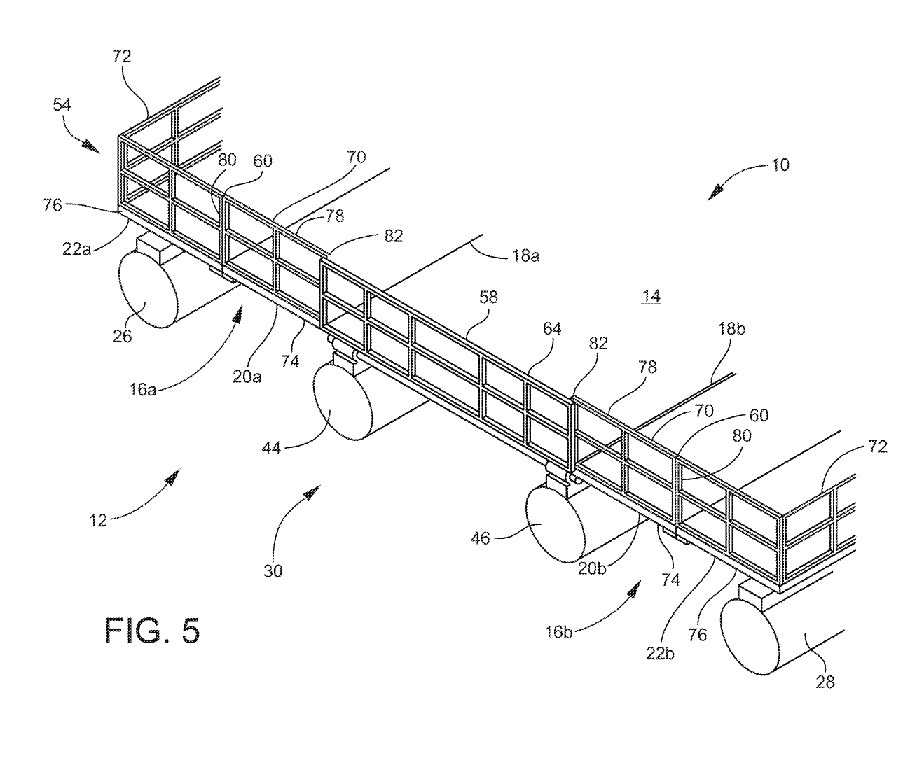

In select embodiments of the expandable flooring system 10 with the railing system 54, when the at least one outer floor 16 includes inner section 20 hingidly connected to outer section 22, inner section 20 may include two ends 74 and outer section 22 may include two ends 76, where each of the two ends 74 and 76 of the inner section 20 and the outer section 22 may include outer end railing section 78 hingidly secured thereon. Whereby, when outer end railing sections 78 of the inner section 20 and the outer section 22 are flipped up, the outer end railing section 78 of the inner section 20 and the outer section 22 may be secured end to end. See FIGS. 4 and 5. In select embodiments of the expandable flooring system 10 with the railing system 54, the outer end railings 70 may overlap the center end railings 64.

As shown in the Figures, in select embodiments of the expandable flooring system 10 with the railing system 54, the expandable flooring system 10 may include the center floor 14, first outer floor 16a configured to expand beside center floor 14 on one side 18a, and second outer floor 16b may be configured to expand beside the center floor 14 on another side 18b. The first outer floor 16a may include two ends 66a and a side 18a opposite of the center floor 14, each of the two ends 66a may include outer end railing 70a hingidly secured thereon, and the side 18a opposite of the center floor 14 may include side railing 72a thereon. The second outer floor 16a may include two ends 66b and side 18n opposite of the center floor 14, each of the two ends 66b may include outer end railing 70b hingidly secured thereon, and the side 18b opposite of the center floor 14 may include side railing 72b thereon. Whereby, when first and second outer floors 16a and 16b are expanded beside center floor 14, each of the outer end railings 70a and 70b may be configured to flip up and secure to the corresponding center end railing 64, and the side railings 72a and a 72b may be configured to flip up and secured at its ends to the outer end railings 70a and 70b.

As discussed above, although the instant disclosure is described and shown for use as an extended use pontoon device, the disclosure is not so limited. The disclosed foldable or extendable flooring system may be utilized in other similar device, including, but not limited to campers, recreational vehicles (“RVs”), motorhomes, trailers, the like, etc. As an example, one such option would be a camper, or more explicitly a pull-out camper configuration with the foldable or extendable flooring system described herein. As such, the camper or pull-out camper configuration can be created with improved widths that would have been unstable prior to the instant disclosure.

The design of the expandable flooring system 10 addresses all four of the issues mentioned above: maximizing the deck space of the boat once expanded, while still having a package that can be transported on a typical highway; allowing for maximum cargo carrying capability; ensuring a rigid structure once expanded; and ability to maintain a center console platform rather than a side console to maximize deck usage once expanded. The disclosure proposed is unique in that it can incorporate 2, 3 or 4 pontoons. The inner and outer pontoons are allowed to slide on their own independent track or tubes which extend the entire width of the center floor 14 section. This may be different from all current or known expandable pontoon boats. Since the outriggers 32 and slide tracks 34 do not slide inside of each other, the length that the pontoon width can expand is only limited by the length of the slide track, the width of the highway on which it will be transported, and the initial width of the center deck 14. This may allow the inner pontoons 44 and 46 to be separated the full width of the center floor 14 (giving added stability). Each of the outer pontoons 26 and 28 may function similar to outriggers and can be extended the full width of the center floor 14. This may allow for the pontoon boat 12 width to be expanded at least 3 times its original width.

In addition, the bi-folding deck can now be extended to more than 3 times the initial width of the center floor 14. Thus, the usable deck space is more than 2 times larger than anything currently on the water that can be trailered without a permit. It should be noted that the expandable flooring system 10 also folds small enough that wind loads should not affect the transportation of the boat on the highway, and the boat 12 will not be top heavy during transport.

The method in which the deck and railing system 54 fold down to reinforce the extended pontoons 26 and 28 is also believed to be unique. The outer railings 72 fold flat for transport, but when folded up into operating position they join in a manner that adds rigidity to the boat deck. The combination of these two items may create a rigid deck despite its large or expanded footprint.

The proposed design of expandable flooring system 10 may maximize the potential width of expansion allowing the boat to be expanded as much as 3X it's original width 36. (See FIG. 1-4). This is accomplished via the unique method utilized to attach the pontoons to the center floor 14. The center floor 14 may have a series of outriggers 32 and tracks 34 that run the entire width of the center floor 14 (See FIGS. 6-7 and 9-10). These outriggers 32 provide an attachment point to the pontoons 26 and 28 via cantilever collars 50 that can slide axially on or in these tracks 34. Each of the outer pontoons 26 and 28 may have its own unique set of slide tracks 34 about which the pontoons can slide laterally under center floor 14. The outer pontoons 26 and 28 are cantilevered to the outriggers 32 via cantilever collars 50. Since the outer pontoons 26 and 28 are cantilevered, they can expand nearly the full width 36 of the initial center deck or floor 14. The inner pontoons 44 and 46 also slide about the slide tracks 34, but they share the slide track 34 that they slide about. In transit the inner pontoons 44 and 46 are simply slid together to touch (minimizing the overall width).

The center floor or deck 14 of the boat 12 may remain fixed. The two outer decks or floors 16 may fold in two places rather than a single pivot point. (See FIGS. 1 and 3). This may allow the expandable flooring system 10 to maintain a minimal height during transit. This may also keep a lower center of gravity during transit and helps minimize the effects of wind loads during transit.

Finally, the railing system 53 on the boat 12 may be designed to fold flat against the deck except for the railings 64 on the center deck (See FIGS. 1 and 3). This may allow the boat 12 to have a smaller footprint when in transit and allows the deck to fold into a smaller package. The railing system 54 however serve another very important function. They add rigidity to the boat 12 due to the way they lock together when in the up position (See FIG. 5). This added rigidity may allow the boat 12 to be wider since the railings can now strengthen the boat deck and sub-structure.

There are several ideas believed to be novel. The first of these is the manner in which the pontoons slide along an independent track. This method allows maximum width expansion for the boat. Unlike other approaches the tubes do not nest. Nesting limits the amount of usable travel. The second idea believed to be novel is the method in which the deck folds to minimize the footprint when in transit. Our proposal allows the deck to fold in at least two locations (there could be more than two). This differs from other ideas where one deck slides over the top of the other. That method limits the amount of total travel and width. Our proposed method is only limited by the width of the highway. Finally, we believe the method of utilizing the railing system 54 to reinforce the boat deck is novel. The method that the railings fold for transit, but then lock into position to reinforce the boat and make it more rigid is unique. Typically boat railing is just an added feature that has no purpose other than to prevent someone from falling from the boat.

The design of expandable flooring system 10 may allow for the widest boat on the water that can be easily transported without having a permit. No other design achieves this amount of usable deck space on the water while being transportable without permit. This design will potentially have the ability to compete with house boats, but has the advantage that it can be pulled out of the water and taken home at the end of the day.

The method used to drive the pontoons outward or inward could vary. This could be performed via hydraulics, pneumatics, belt drives, chain drives, screws or gearing. The same could apply to the method used to fold and unfold the decks. The method used to lock the railings together for stability could vary widely. This could be as simple as bolting or clamps to automated clamps.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. An expandable flooring system comprising:
a center floor; and
at least one outer floor configured to hinge upwards about an edge of the center floor;
wherein, the expandable flooring system is configured to expand by said at least one outer floor hinging downwards flat beside said center floor and configured to retract by said at least one outer floor hinging upwards and on top of said center floor.

2. The expandable flooring system of claim 1, wherein each of said at least one outer floors including an inner section hingidly attached to an outer section, whereby, when said outer floor hinges upwards for retracting of the expandable flooring system, said outer floor hinges together said inner section and said outer section for conserving space on said center floor.

3. The expandable flooring system of claim 2, wherein said inner section hinges on top of said center floor, and said outer section hinges on top of said inner section.

4. The expandable flooring system of claim 3, wherein said outer section having railings hingidly fixed to an outer edge, whereby when said outer floor hinges upwards for retracting of the expandable flooring system, said outer floor hinges together said inner section and said outer section for conserving space on said center floor, wherein said inner section hinges on top of said center floor, said outer section hinges on top of said inner section, and said railings hinge on top of said outer floor.

5. The expandable flooring system of claim 1 including:
the center floor;
a first outer floor configured to hinge upwards about a first edge of said center floor;
a second outer floor configured to hinge upwards about a second edge of said center floor;
wherein, the expandable flooring system is configured to expand by said first outer floor and said second outer floor hinging downwards flat beside said center floor, wherein a first outer pontoon supports said first outer floor and a second outer pontoon supports said second outer floor;
wherein, the expandable flooring system is configured to retract by said first outer floor and said second outer floor hinging upwards and on top of said center floor;
wherein each of said first and second outer floors including an inner section hingidly attached to an outer section, whereby, when said first and second outer floors hinge upwards for retracting of the expandable flooring system, said outer floors hinge together said inner section and said outer section for conserving space on said center floor, wherein said inner sections hinge on top of said center floor, and said outer sections hinge on top of said inner sections;
wherein each of said first and second outer sections having railings hingidly fixed to an outer edge, whereby when said first and second outer floors hinge upwards for retracting of the expandable flooring system, said first and second outer floors hinge together said inner section and said outer section for conserving space on said center floor, wherein said inner sections hinge on top of said center floor, said outer sections hinge on top of their respective inner section, and said railings hinge on top of their respective outer floor.

6. An expandable flooring system comprising:
a center floor and at least one outer floor;
a slide track system configured to support the at least one outer floor when it is expanded out beside said center floor and to slide under the center floor when the at least one outer floor is retracted, said slide track system comprising:
at least one outrigger that is extendable from a corresponding slide track under the center floor, said outrigger is configured to:
slide inside the slide track under the center floor when the outer floor is retracted; and
slide out from the slide track and from under the center floor for supporting the outer floor when it is expanded out beside said center floor.

7. The expandable flooring system of claim 6, wherein each of the at least one outriggers having its own corresponding slide track under the center floor.

8. The expandable flooring system of claim 7, wherein each of the corresponding slide tracks extending under the center floor for a width of the center floor, whereby the outrigger is extendable from the slide track an extension width which is approximately the width of the center floor.

9. The expandable flooring system of claim 6, wherein each of the at least one outriggers is cantilevered with its corresponding slide track for supporting the outrigger when it is slid out from the center floor for supporting the outer floor when it is expanded out beside said center floor.

10. The expandable flooring system of claim 9, wherein each of the at least one outriggers has a rectangular cross-section or a circular cross-section, and its corresponding slide track has a rectangular channel or circular channel configured to allow the rectangular outrigger to slide therein while providing cantilever forces.

11. The expandable flooring system of claim 6 including at least two pontoons, including at least one outer pontoon connected to the at least one outrigger.

12. The expandable flooring system of claim 6 including:
the center floor;
a first outer floor connected to a first edge of the center floor; and
a second outer floor connected to a second edge of the center floor;
wherein, the slide track system is configured to support the first outer floor and the second outer floor when they are expanded out beside said center floor and to slide under the center floor when the first outer floor and the second outer floor are retracted, said slide track system comprising:
at least one first outrigger that is extendable from a corresponding first slide track under the center floor, said first outrigger is configured to:
slide in the first slide track under the center floor when the first outer floor is retracted; and
slide out from the first slide track and from the center floor for supporting the first outer floor when it is expanded out beside said center floor; and
at least one second outrigger that is extendable from a corresponding second slide track under the center floor, said second outrigger is configured to:
slide in the second slide track under the center floor when the second outer floor is retracted; and
slide out from the second slide track and from the center floor for supporting the second outer floor when it is expanded out beside said center floor.

13. The expandable flooring system of claim 12, wherein the track system including:
five first outriggers and five corresponding first slide tracks, and five second outriggers and five corresponding second slide tracks; or
three first outriggers and three corresponding first slide tracks, and three second outriggers and three corresponding second slide tracks.

14. The expandable flooring system of claim 12 including four pontoons:
a first inner pontoon slidable under the center floor;
a second inner pontoon slidable under the center floor;
a first outer pontoon connected to each of the at least one first outriggers; and
a second outer pontoon connected to each of the at least one second outriggers;
whereby:
when the expandable flooring system is expanded, the first outer pontoon supports the first outer floor, the second outer pontoon supports the second outer floor, and the first and second inner pontoons are configured to slide to the edges of the center floor for stabilizing the center floor; and
when the expandable flooring system is retracted, the first outer pontoon, the second outer pontoon, the first inner pontoon and the second inner pontoon are configured to slide beneath the center floor.

15. The expandable flooring system of claim 14, wherein:
the inner pontoons are connected to their corresponding slide tracks via slide collars, said slide collars are configured to slide along said slide tracks; and
the outer pontoons are connected to their corresponding outriggers via cantilever collars, said cantilever collars are configured to provide cantilever forces to support the outer floors.

16. An expandable flooring system comprising:
a center floor;
at least one outer floor configured to expand beside said center floor; and
a railing system around a periphery of the expandable flooring system when in expanded form;
said railing system is configured to link together railing sections of said center floor with railing sections of said at least one outer floor for reinforcing the expandable flooring system; and
said railing system is configured to fold down when the expandable flooring system is retracted.

17. The expandable flooring system of claim 16, wherein:
the center floor including two ends, each of the two ends of the center floor including a center end railing secured thereon;
the at least one outer floor including two ends and a side opposite of the center floor, each of the two ends including an outer end railing hingidly secured thereon, and the side opposite of the center floor including a side railing hingidly secured thereon;
whereby, when the outer floor is expanded beside the center floor, each of the outer end railings are configured to flip up and secure to the corresponding center end railing, and the side railing is configured to flip up and secured at its ends to the outer end railings.

18. The expandable flooring system of claim 17, wherein:
the at least one outer floor including an inner section hingidly connected to an outer section, the inner section including two ends and the outer section including two ends, each of the two ends of the inner section and outer section including an outer end railing section hingidly secured thereon;
whereby, when the outer end railings of the inner section and the outer section are flipped up, the outer end railings of the inner section and the outer section are secured end to end.

19. The expandable flooring system of claim 17, wherein the outer end railings overlap the center end railings.

20. The expandable flooring system of claim 17 comprising:
a first outer floor configured to expand beside said center floor on one side;
a second outer floor configured to expand beside said center floor on another side;
the first outer floor including two ends and a side opposite of the center floor, each of the two ends including an outer end railing hingidly secured thereon, and the side opposite of the center floor including a side railing thereon;
the second outer floor including two ends and a side opposite of the center floor, each of the two ends including an outer end railing hingidly secured thereon, and the side opposite of the center floor including a side railing thereon;
whereby, when the first and second outer floors are expanded beside the center floor, each of the outer end railings are configured to flip up and secure to the corresponding center end railing, and the side railings are configured to flip up and secured at its ends to the outer end railings.
